(19) United States
(12) Patent Application Publication
(10) Pub. No.: US 2025/0336992 A1
(43) Pub. Date: Oct. 30, 2025

(54) COMBINED PREDICTION METHOD FOR PROTON EXCHANGE MEMBRANE (PEM) DEVICE, APPARATUS, MEDIUM, AND PRODUCT

(71) Applicant: Tongji University, Shanghai (CN)

(72) Inventors: Haifeng Dai, Shanghai (CN); Jiangong Zhu, Shanghai (CN); Hao Yuan, Shanghai (CN); Xuezhe Wei, Shanghai (CN); Haoyu Zhang, Shanghai (CN); Yufeng Wu, Shanghai (CN)

(73) Assignee: Tongji University, Shanghai (CN)

(21) Appl. No.: 18/646,843

(22) Filed: Apr. 26, 2024

(51) Int. Cl. H01M 8/04298; C25B 15/027; H01M 8/0432; H01M 8/0438; H01M 8/04537; H01M 8/04992

(52) U.S. Cl. CPC H01M 8/04305; C25B 15/027; H01M 8/0432; H01M 8/04402; H01M 8/0441; H01M 8/04574; H01M 8/04992

(57) ABSTRACT

The present disclosure provides a combined prediction method for a proton exchange membrane (PEM) device, an apparatus, a medium, and a product. The combined prediction method for a PEM device includes: acquiring operational data sequence of a PEM device, where the PEM device is a PEM fuel cell or a PEM electrolyzer, operational data of the PEM fuel cell includes a cell output current, a cell temperature, an anode dew-point temperature, a cathode dew-point temperature, a cathode air metering ratio, an anode gas pressure, and a cathode gas pressure, and operational data of the PEM electrolyzer includes a water flow, a water temperature, and an electrolytic current; and taking the operational data sequence as an input, and performing combined prediction on output data of the PEM device at a prediction timepoint with a well-trained prediction model, the output data including an output voltage and a resistance.

### TECHNICAL FIELD

The present disclosure relates to the technical field of combined prediction, and in particular to a combined prediction method for a proton exchange membrane (PEM) device, an apparatus, a medium, and a product.

### BACKGROUND

As an important sector in low-carbon energy transition, hydrogen energy will become a key pillar for constructing an environment-friendly, efficient and safe new energy system. In industrial systems of the hydrogen energy, a PEM device is considered as an important utilization form of the hydrogen energy. For the sake of a longer service life of the PEM device, an output voltage is predicted to optimize an energy management strategy. In addition, a resistance is also commonly used to diagnose a fault of the PEM device. If the resistance of the PEM device can be predicted online in operation to realize reasonable control on the PEM device, the fault of the PEM device can be prevented to achieve the longer service life. However, a complex or empirical mechanism model is to be constructed to predict the output voltage and the resistance of the PEM device, thus causing a poor timeliness.

### SUMMARY

An objective of the present disclosure is to provide a combined prediction method for a PEM device, an apparatus, a medium, and a product. The present disclosure can realize combined prediction on an output voltage and a resistance of the PEM device, without establishing a complex or empirical mechanism model, and with a desirable timeliness.

To achieve the above objective, the present disclosure provides the following technical solutions.

A combined prediction method for a PEM device includes:
acquiring operational data sequence of a PEM device, where the operational data sequence includes operational data in multiple consecutive timepoints; and the PEM device is a PEM fuel cell or a PEM electrolyzer, if the PEM device is the PEM fuel cell, the operational data includes a cell output current, a cell temperature, an anode dew-point temperature, a cathode dew-point temperature, a cathode air metering ratio, an anode gas pressure, and a cathode gas pressure, and if the PEM device is the PEM electrolyzer, the operational data includes a water flow, a water temperature, and an electrolytic current; and
taking the operational data sequence as an input, and performing combined prediction on output data of the PEM device at a prediction timepoint with a well-trained prediction model, the output data including an output voltage and a resistance.

A computer apparatus includes a memory, a processor, and a computer program stored in the memory and executable on the processor, where the processor executes the computer program to implement steps of the combined prediction method for a PEM device.

A computer-readable storage medium stores a computer program, where the computer program is executed by a processor to implement steps of the combined prediction method for a PEM device.

A computer program product includes a computer program, where the computer program is executed by a processor to implement steps of the combined prediction method for a PEM device.

According to specific embodiments provided by the present disclosure, the present disclosure discloses the following technical effects:

According to the combined prediction method for a PEM device, the apparatus, the medium and the product provided by the present disclosure, operational data sequence of a PEM device is acquired. The PEM device is a PEM fuel cell or a PEM electrolyzer. Operational data of the PEM fuel cell includes a cell output current, a cell temperature, an anode dew-point temperature, a cathode dew-point temperature, a cathode air metering ratio, an anode gas pressure, and a cathode gas pressure. Operational data of the PEM electrolyzer includes a water flow, a water temperature, and an electrolytic current. The operational data sequence is taken as an input, and combined prediction is performed on output data of the PEM device at a prediction timepoint with a well-trained prediction model. The output data includes an output voltage and a resistance. The present disclosure can realize combined prediction on the output voltage and the resistance of the PEM device by directly using the well-trained prediction model, without establishing a complex or empirical mechanism model, and with a desirable timeliness.

### BRIEF DESCRIPTION OF THE DRAWINGS

The accompanying drawings required for the embodiments will be briefly described below.

FIG. 1 schematically illustrates a flowchart of a combined prediction method according to Embodiment 1 of the present disclosure;

FIG. 2 schematically illustrates a sliding window algorithm according to Embodiment 1 of the present disclosure;

FIG. 3 schematically illustrates a combined prediction framework on a resistance and an output voltage according to Embodiment 1 of the present disclosure;

FIG. 4 schematically illustrates a convolution operation according to Embodiment 1 of the present disclosure;

FIG. 5 schematically illustrates a shortcut structure according to Embodiment 1 of the present disclosure;

FIG. 6 schematically illustrates a fully connected layer according to Embodiment 1 of the present disclosure;

FIGS. 7A-7C schematically illustrate attention mechanism according to Embodiment 1 of the present disclosure;

FIG. 8 schematically illustrates a result of high-frequency resistance (HFR)-output voltage combined prediction of a fuel cell according to Embodiment 1 of the present disclosure; and

FIG. 9 schematically illustrates a result of low-frequency resistance (LFR)-output voltage combined prediction of a fuel cell according to Embodiment 1 of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure.

### Embodiment 1

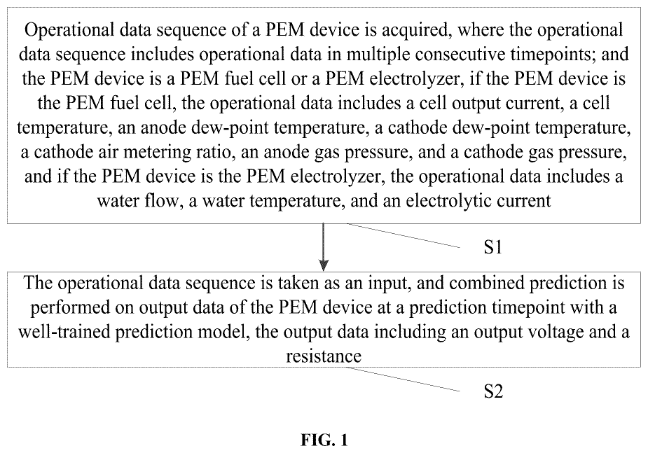

As shown in FIG. 1, the embodiment provides a combined prediction method for a PEM device, including the following steps:

In S1: Operational data sequence of a PEM device is acquired, where the operational data sequence includes operational data in multiple consecutive timepoints; and the PEM device is a PEM fuel cell or a PEM electrolyzer, if the PEM device is the PEM fuel cell, the operational data includes a cell output current, a cell temperature, an anode dew-point temperature, a cathode dew-point temperature, a cathode air metering ratio, an anode gas pressure, and a cathode gas pressure, and if the PEM device is the PEM electrolyzer, the operational data includes a water flow, a water temperature, and an electrolytic current.

In S2: The operational data sequence is taken as an input, and combined prediction is performed on output data of the PEM device at a prediction timepoint with a well-trained prediction model, the output data including an output voltage and a resistance.

In the embodiment, the well-trained prediction model includes two feature extraction blocks, a flatten layer, a dropout layer, and a fully connected layer that are connected sequentially. The feature extraction blocks each include a first convolutional layer, a pooling layer, an activation layer, a spatial squeeze-and-excite (sSE) block, a second convolutional layer, a channel SE (cSE) block, a first multiplication layer, a second multiplication layer, and an addition layer. The first convolutional layer, the pooling layer, and the activation layer are connected sequentially. An output end of the activation layer is connected to the sSE block, the second convolutional layer, the cSE block, and the addition layer. An output end of the sSE block is connected to the first multiplication layer. An output end of the second convolutional layer is connected to the first multiplication layer and the second multiplication layer. An output end of the cSE block is connected to the second multiplication layer. An output end of the first multiplication layer is connected to the addition layer. An output end of the second multiplication layer is connected to the addition layer.

In the embodiment, the prediction timepoint is a last timepoint of the operational data sequence. Considering that the PEM fuel cell and the PEM electrolyzer have an internal state related to a time-accumulation effect, the whole time sequence of the operational data sequence serves as a network input, so as to predict the output voltage and the resistance more accurately.

In the embodiment, an HFR and an LFR can be predicted at the same time. If the PEM device is the PEM fuel cell, the resistance includes a 2,500-Hz HFR and a 10-Hz LFR. If the PEM device is the PEM electrolyzer, the resistance includes a 1,000-Hz HFR and a 1-Hz LFR.

Before the operational data sequence is taken as an input, and combined prediction is performed on output data of the PEM device at a prediction timepoint with a well-trained prediction model, the combined prediction method in the embodiment further includes: An initial prediction model is trained to obtain the well-trained prediction model, specifically:
(1) Original data capable of describing operation of the PEM device is acquired through a test, the original data including operational data and output data in the multiple consecutive timepoints.

In the embodiment, the original data is acquired through multiple bench tests. The original data includes model input data (namely the operational data) and model output data (namely the output data). In the embodiment, a most commonly used signal of the PEM device with a low measurement cost is selected as the model input data. For the PEM fuel cell, the model input data is the cell output current, the cell temperature, the anode dew-point temperature, the cathode dew-point temperature, the cathode air metering ratio, the anode gas pressure, and the cathode gas pressure, while the model output data is the output voltage, the 2,500-Hz HFR, and the 10-Hz LFR. For the PEM electrolyzer, the model input data is the water flow, the water temperature, and a current in an electrolytic process (namely the electrolytic current, which may also be referred to as a working current), while the model output data is the output voltage, the 1,000-Hz HFR, and the 1-Hz LFR. When the original data is acquired, data of the fuel cell and the electrolyzer that can be acquired by an existing common sensor is selected as a network input. This has a low measurement cost, and is conveniently implemented in the fuel cell and the electrolyzer.

In the embodiment, for the PEM fuel cell, with a bench test of a commercial membrane electrode as an example, there are four input currents. In the four input currents, two currents are used for combined prediction of the HFR (2,500 Hz) and the output voltage, and two currents are used for combined prediction of the LFR (10 Hz) and the output voltage.
(2) The original data is processed with a sliding window algorithm to obtain a dataset. The dataset includes multiple operational data sequence samples and an output data sample corresponding to each of the operational data sequence samples.

The sliding window algorithm on the original data is intended to add a concept of the time-accumulation effect to network prediction. Specifically, all signals within a time period previous to a timepoint to be predicted are taken as a whole, such that original single signal relations becomes an assemble of the signals with respect to a time sequence, and the network can predict a result according to a historical information, thereby achieving the more accurate result. In the embodiment, the sliding window algorithm is used to clean the original data, so as to remove abnormal data possibly causing non-convergence in model training, and form a sample required by the model training and test, thus obtaining the dataset.

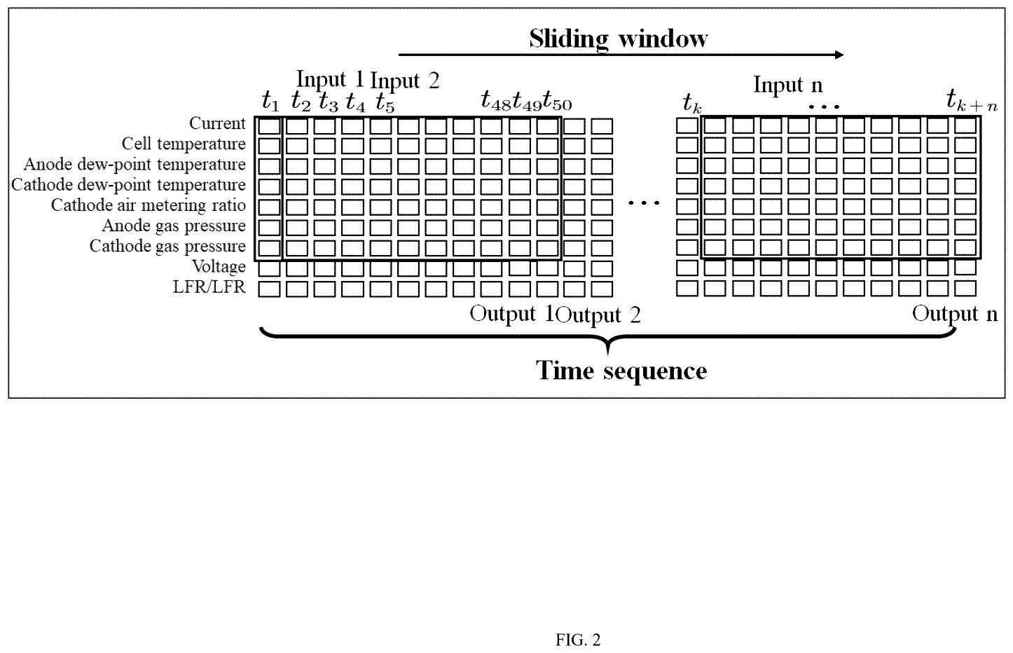

As shown in FIG. 2, the sliding window algorithm specifically includes:
1) A width of a window is set as w. The w may beset as 10 s, 50 s or 100 s.
2) For the PEM fuel cell, the cell output current, the cell temperature, the anode dew-point temperature, the cathode dew-point temperature, the cathode air metering ratio, the anode gas pressure, the cathode gas pressure, the output voltage, and the resistance are flattened as one two-dimensional (2D) plane according to time. For the PEM electrolyzer, the water flow, the water temperature, the electrolytic current, the output voltage, and the resistance are flattened as one 2D plane according to time.
3) It is assumed that a first timepoint of the window is a first timepoint for acquiring the original data, thereby obtaining a first window.
4) For the PEM fuel cell, a time sequence for the cell output current, the cell temperature, the anode dew-point temperature, the cathode dew-point temperature, the cathode air metering ratio, the anode gas pressure, and the cathode gas pressure in the window is taken as an operational data sequence sample, while the output voltage and the resistance at a last timepoint of the window are taken as an output data sample, thereby forming a complete sample. For the PEM electrolyzer, a time sequence for the water flow, the water temperature, and the electrolytic current in the window is taken as an operational data sequence sample, while the output voltage and the resistance at a last timepoint of the window are taken as an output data sample, thereby forming a complete sample.
5) The window is moved backward by one timepoint, and Step 4) is repeated, until a last timepoint of the window is a last timepoint for acquiring the original data.
6) All samples are integrated to form the dataset for the model training and the test.
(3) The initial prediction model is trained with the dataset to obtain the well-trained prediction model.

Before the initial prediction model is trained with the dataset, the combined prediction method in the embodiment further includes: The dataset is normalized to obtain a normalized dataset, and the normalized dataset is taken as a new dataset to train the initial prediction model.

The step that the initial prediction model is trained with the dataset to obtain the well-trained prediction model may include:
1) The dataset is randomly divided into a training set and a test set. The training set is used to train the network. The test set is used to test and evaluate the network.

After divided into the training set and the test set, the dataset is normalized, specifically: The training set is normalized to improve a convergence speed and a training accuracy of the network. The test set is strange to the model, and in order to simulate an actual use scenario in test, the test set is considered being priorly unknown. However, the test set is also to be normalized. Normalization parameters (namely a mean and a variance calculated in normalization of the training set) for normalizing the training set are reused to normalize the test set.

The test set is specifically normalized by:

$$\begin{matrix}{μ}_{B} = \frac{1}{m} {\sum }_{i = 1}^{m} {x}_{i} \\ {σ}_{B} = \sqrt{\frac{1}{m} {\sum }_{i = 1}^{m} {( {x}_{i} - {μ}_{B} )}^{2}} \\ {\hat{x}}_{i} = \frac{{x}_{i} - {μ}_{B}}{{σ}_{B}}\end{matrix}$$

In the foregoing equation, μ_{B} is a mean, m is a number of sampling points in an original data sequence (a sequence formed by all samples in the training set), xᵢ is a value of an ith sampling point in the original data sequence, σ_{B} is a variance, and \hat{x}ᵢ is a normalized sequence.
2) The initial prediction model is trained with the training set to obtain the well-trained prediction model. The well-trained prediction model is tested with the test set to determine an accuracy of the well-trained prediction model.

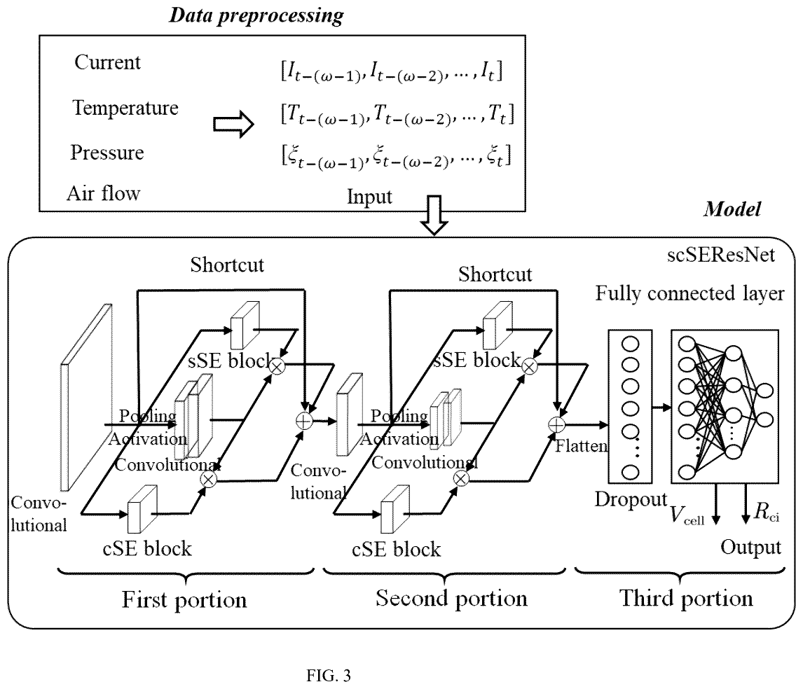

In the embodiment, a spatial and channel SE based residual network (scSEResNet) is established in advance to serve as the initial prediction model. The scSEResNet mainly includes a convolutional layer, a pooling layer, an activation layer, an attention mechanism, a shortcut layer, a dropout layer, and a fully connected layer, with a specific structure shown in FIG. 3. In FIG. 3, I represents a cell output current, T represents a cell temperature, ξ represents a cathode air metering ratio, V represents an output voltage, and R represents a resistance. The initial prediction model includes two feature extraction modules, a flatten layer, a dropout layer, and a fully connected layer that are connected sequentially. The feature extraction blocks each include a first convolutional layer, a pooling layer, an activation layer, an sSE block, a second convolutional layer, a cSE block, a first multiplication layer, a second multiplication layer, and an addition layer. The first convolutional layer, the pooling layer, and the activation layer are connected sequentially. An output end of the activation layer is connected to the sSE block, the second convolutional layer, the cSE block, and the addition layer. An output end of the sSE block is connected to the first multiplication layer. An output end of the second convolutional layer is connected to the first multiplication layer and the second multiplication layer. An output end of the cSE block is connected to the second multiplication layer. An output end of the first multiplication layer is connected to the addition layer. An output end of the second multiplication layer is connected to the addition layer. In the embodiment, network parameters at each layer are set.

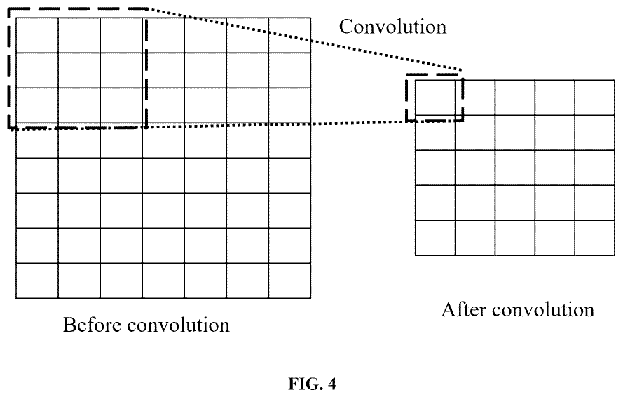

A main operation of the convolutional layer (namely the first convolutional layer and the second convolutional layer) is as shown in FIG. 4. As a core layer for constructing a convolutional neural network (CNN), the convolutional layer functions to perform feature extraction on input data with multiple convolution kernels. For one-dimensional (1D) convolution, if input data of the convolutional layer is x_{1:n}=[x₁, x₂, . . . , xₙ], output data of the convolutional layer is cᵢ=wx_{1:n}+b, w and b are respectively a weight and a deviation in convolution.

The pooling layer substantially refers to subsampling. The pooling layer is provided between consecutive convolutional layers, so as to compress data and parameters, and reduce overfitting.

The activation layer makes an output of a nonlinear mapping convolutional layer approximate to any nonlinear model. A rectified linear unit (ReLU) activation function is usually used by the CNN to achieve rapid convergence and simple gradient computation.

$$f ( x ) = \{ \begin{matrix}x & x \geq 0 \\ 0 & x < 0\end{matrix}$$

In the foregoing equation, f(x) is an output of the ReLU, and x is an input of the ReLU.

A Sigmoid activation function may also be used in the embodiment, and expressed by:

$$S ( x ) = \frac{1}{1 - {e}^{- x}}$$

In the foregoing equation, S(x) is an output of the Sigmoid, and x is an input of the Sigmoid.

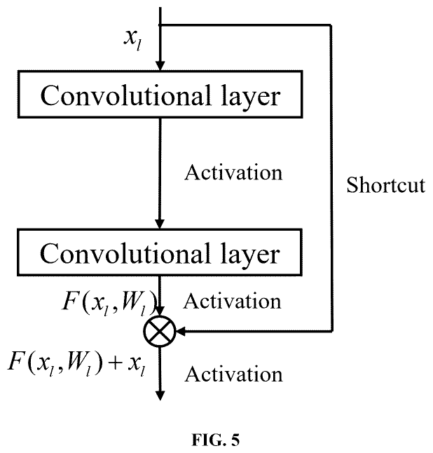

The shortcut layer serves as a core portion of the ResNet, with a structure shown in FIG. 5. Compared with a common CNN, the ResNet is further provided with the shortcut layer. The shortcut layer functions to directly add a former layer to a later layer, so as to prevent data of the network on the former layer from losing in transmission, and improving a prediction accuracy of the network, with an equation given by:

$${x}_{l + 1} = {x}_{l} + F ( {x}_{l} , {W}_{l} )$$

In the foregoing equation, xₗ₊₁ is input data of an (l+1)th layer, xₗ is input data of an lth layer, F(xₗ, Wₗ) is output data of the lth layer, and Wₗ is a parameter of the lth layer.

The dropout layer functions to abandon at least one of neurons in each training to improve a generalization ability of the network.

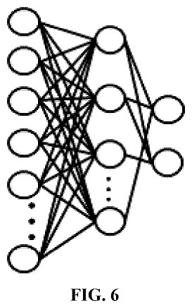

The fully connected layer is to connect weights and offsets of all neurons between two layers. The fully connected layer is usually located at a tail end of the CNN, with a structure shown in FIG. 6.

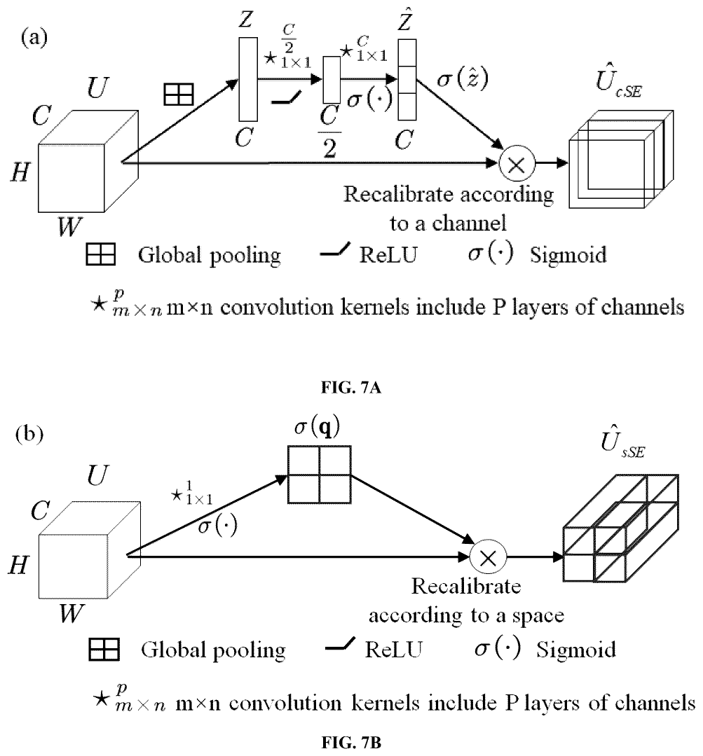

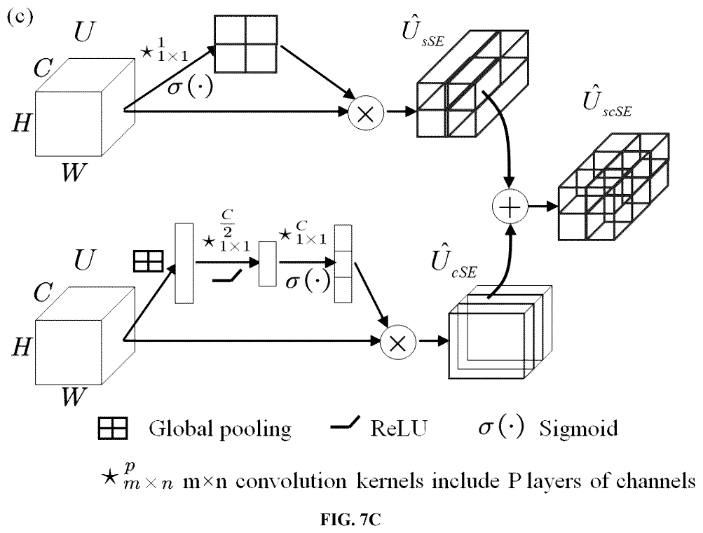

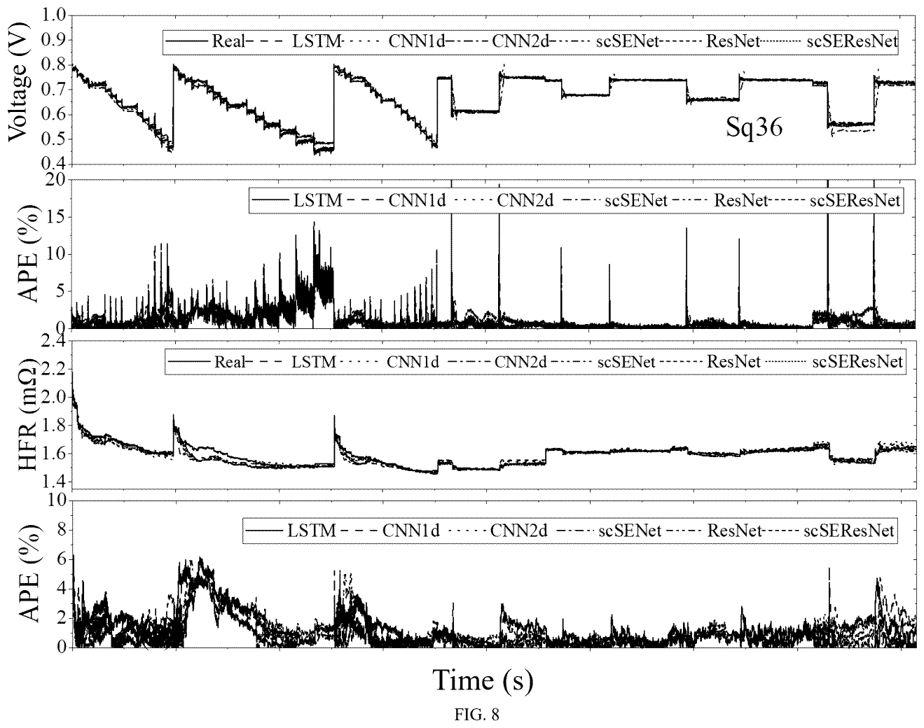

The attention mechanism utilizes a spatial and channel SE (scSE) block combined with an sSE and a cSE. By weighting spatial parameters and channel parameters, the attention mechanism makes the network more sensitive to different spatial and channel features, thereby extracting more useful features for model training, as shown in FIGS. 7A-7C. In FIGS. 7A-7C, W, H and C respectively represent a width, a height, and channels of an input feature map, U represents the input feature map, and Û_{cSE}, Û_{sSE}, Û_{scSE} each represent an output feature map. FIG. 7A illustrates the cSE. In the cSE, global spatial information of a feature map is formed into a 1D vector on a channel through pooling. An attention of each channel is weighted to the feature map to calibrate the channel of the feature map, thereby strengthening a channel feature of the feature map. FIG. 7B illustrates the sSE. In the sSE, global spatial information of a feature map is formed into a 2D vector through convolution. An attention of each space is weighted to the feature map to calibrate the feature map, thereby strengthening a spatial feature of the feature map. FIG. 7C illustrates the scSE. In the scSE, a result of a channel attention and a result of a spatial attention are combined as a brand-new output, such that the network can learn more associated feature information.

In the embodiment, training parameters of the network are further set. When the initial prediction model is trained with the training set, the training parameters include a learning rate, a number of training times, a batch size, and a gradient threshold. A mean square error (MSE) serves as a loss function. An Adam algorithm serves as an optimization algorithm. The network is trained with the Adam algorithm. Through continuous optimization and iteration, an optimal network is stored. Therefore, the model is trained completely.

The test set is input to the well-trained prediction model. Combined online prediction is performed on the resistance and the output voltage to obtain a resistance predicted value and an output voltage predicted value. An accuracy of the resistance predicted value and an accuracy of the output voltage predicted value are evaluated. In accuracy evaluation, three evaluation indicators, including a root mean squared error (RMSE), a mean absolute percentage error (MAPE), and an absolute percentage error (APE), are used to compute an accuracy of an online predicted result.

The RMSE is computed by:

$$RMSE = \sqrt{\frac{{\sum }_{i = 1}^{N} {( {y}_{i} - {\hat{y}}_{i} )}^{2}}{N}} .$$

In the foregoing equation, RMSE is the root mean squared error, N is a total number of samples in the test set, yᵢ is an actual resistance or an actual output voltage of an ith sample in the test set, and ŷᵢ is a predicted resistance or a predicted output voltage of the ith sample in the test set.

The MAPE is computed by:

$$MAPE = \frac{1}{N} {\sum }_{i = 1}^{N} \frac{\vert {y}_{i} - {\hat{y}}_{i} \vert}{{y}_{i}} \times 100 \% .$$

In the foregoing equation, MAPE is the mean absolute percentage error.

The APE is computed by:

$${APE}_{i} = \frac{\vert {y}_{i} - {\hat{y}}_{i} \vert}{{y}_{i}} \times 100 \% .$$

In the foregoing equation, APEᵢ is an APE of the ith sample in the test set.

The embodiment provides a combined online prediction method for a resistance and an output voltage of a PEM fuel cell and a PEM electrolyzer with a better accuracy and a higher timeliness, thereby monitoring and controlling an internal state of the PEM fuel cell and the PEM electrolyzer, and prolonging a service life of the PEM fuel cell and the PEM electrolyzer. Specifically, original data capable of describing operation of the fuel cell or the electrolyzer is acquired through a test. The original data is processed with a sliding window algorithm to obtain a dataset. The dataset is divided into a training set and a test set, and normalized. An scSENet is constructed. Training parameters are set. The training set is used to train a model. The test set is input to a trained model. A resistance and an output voltage are predicted online, and an accuracy is evaluated. From now on, the well-trained prediction model can be used directly to perform combined online prediction on the resistance and the output voltage, without establishing a complex or empirical fuel cell resistance mechanism model or an electrolyzer resistance mechanism model, and without taking complex excitation hardware and high-frequency sampling hardware as an assistance. A whole operational data sequence is directly taken as a network input. Based on an scSEResNet, combined prediction on the resistance and the output voltage of the fuel cell or the electrolyzer is performed online. The method can predict the resistance and the output voltage of the fuel cell or the electrolyzer online efficiently, accurately and timely. Not only is online prediction time greatly shortened, but also the resistance and the output voltage are provided for the fuel cell or the electrolyzer in different working conditions, and real-time information is provided for health management of the fuel cell or the electrolyzer.

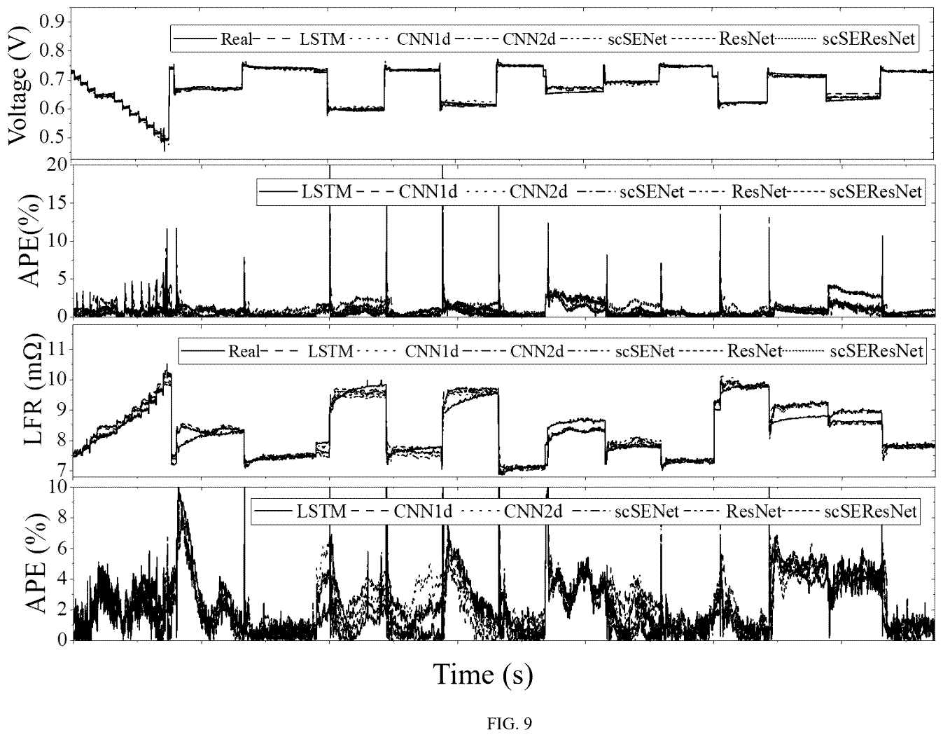

In order to verify effectiveness of the combined prediction method in the embodiment, different algorithms are further used to predict the HFR and the LFR, with a comparison result shown in FIG. 8, FIG. 9 and Table 1. Herein, Real represents a real value, CNN1d represents a one-dimensional convolutional neural network, CNN2d represents a two-dimensional convolutional neural network, LSTM represents a long short-term memory, scSENet represents a spatial and channel SE network, ResNet represents a residual network, scSEResNet represents a spatial and channel SE based residual neural network in the embodiment, HFR represents a resistance, and APE represents an absolute percentage error. As can be seen, the scSEResNet used in the embodiment has a higher accuracy than the pure CNN in HFR-output voltage combined prediction or the LFR-output voltage combined prediction. The accuracy of the scSEResNet is improved over the scSENet and the ResNet, and is also higher than the accuracy of the LSTM for solving a timing problem in deep learning. The scSEResNet shows the higher accuracy than other models, despite long online training time. Meanwhile, for the test set with the time of 3,000 s, and the sampling frequency of 1 Hz, the online prediction time of 7.55 s or 6.53 s can meet the demand of real time. This indicates that the method provided in the embodiment is very suitable for high-accuracy online applications, and for a large number of data samples of future commercial vehicles.

TABLE 1
Comparison on results of different algorithms
in resistance-voltage combined prediction

| | | Online | RMSE | | MAPE | |
|---|---|---|---|---|---|---|
| | | prediction | Voltage | Resistance | Voltage | Resistance |
| | Algorithm | time (s) | (V) | (mΩ) | (%) | (%) |
| HFR-output | scSEResNet | 7.55 | 0.009649 | 0.021619 | 0.951268 | 0.928555 |
| voltage combined | LSTM | 3.59 | 0.010895 | 0.025986 | 1.142445 | 1.175851 |
| prediction | CNN1d | 5.82 | 0.012195 | 0.024831 | 1.229564 | 1.058551 |
| | CNN2d | 6.15 | 0.010913 | 0.025254 | 1.099244 | 1.056808 |
| | ResNet | 7.63 | 0.010551 | 0.023147 | 0.995585 | 0.975526 |
| | scSENet | 7.57 | 0.010779 | 0.022962 | 1.064881 | 0.968422 |
| LFR-output | scSEResNet | 6.53 | 0.008443 | 0.237769 | 0.788093 | 2.106922 |
| voltage combined | LSTM | 3.75 | 0.008604 | 0.254743 | 0.880646 | 2.242305 |
| prediction | CNN1d | 4.86 | 0.010859 | 0.254207 | 1.150472 | 2.283158 |
| | CNN2d | 5.27 | 0.008765 | 0.249042 | 0.85851 | 2.355129 |
| | ResNet | 6.04 | 0.008604 | 0.252572 | 0.821923 | 2.254131 |
| | scSENet | 6.26 | 0.008676 | 0.250709 | 0.823274 | 2.242836 |

### Embodiment 2

A computer apparatus includes a memory, a processor, and a computer program stored in the memory and executable on the processor. The processor executes the computer program to implement steps of the combined prediction method for a PEM device in Embodiment 1.

### Embodiment 3

A computer-readable storage medium stores a computer program. The computer program is executed by a processor to implement steps of the combined prediction method for a PEM device in Embodiment 1.

### Embodiment 4

A computer program product includes a computer program. The computer program is executed by a processor to implement steps of the combined prediction method for a PEM device in Embodiment 1.

Contents in the description cannot be understood as limits to the present disclosure.

What is claimed is:

1. A combined prediction method for a proton exchange membrane (PEM) device, comprising:
acquiring operational data sequence of a PEM device, wherein the operational data sequence comprises operational data in multiple consecutive timepoints; and the PEM device is a PEM fuel cell or a PEM electrolyzer, if the PEM device is the PEM fuel cell, the operational data comprises a cell output current, a cell temperature, an anode dew-point temperature, a cathode dew-point temperature, a cathode air metering ratio, an anode gas pressure, and a cathode gas pressure, and if the PEM device is the PEM electrolyzer, the operational data comprises a water flow, a water temperature, and an electrolytic current; and
taking the operational data sequence as an input, and performing combined prediction on output data of the PEM device at a prediction timepoint with a well-trained prediction model, the output data comprising an output voltage and a resistance.

2. The combined prediction method for a PEM device according to claim 1, wherein the well-trained prediction model comprises two feature extraction blocks, a flatten layer, a dropout layer, and a fully connected layer that are connected sequentially; and
the feature extraction blocks each comprise a first convolutional layer, a pooling layer, an activation layer, a spatial squeeze-and-excitation (sSE) block, a second convolutional layer, a channel SE (cSE) block, a first multiplication layer, a second multiplication layer, and an addition layer; the first convolutional layer, the pooling layer, and the activation layer are connected sequentially; an output end of the activation layer is connected to the sSE block, the second convolutional layer, the cSE block, and the addition layer; an output end of the sSE block is connected to the first multiplication layer; an output end of the second convolutional layer is connected to the first multiplication layer and the second multiplication layer; an output end of the cSE block is connected to the second multiplication layer; an output end of the first multiplication layer is connected to the addition layer; and an output end of the second multiplication layer is connected to the addition layer.

3. The combined prediction method for a PEM device according to claim 1, wherein if the PEM device is the PEM fuel cell, the resistance comprises a 2,500-Hz resistance and a 10-Hz resistance; and if the PEM device is the PEM electrolyzer, the resistance comprises a 1,000-Hz resistance and a 1-Hz resistance.

4. The combined prediction method for a PEM device according to claim 1, before the taking the operational data sequence as an input, and performing combined prediction on output data of the PEM device at a prediction timepoint with a well-trained prediction model, further comprising:
acquiring original data of the PEM device, the original data comprising operational data and output data in the multiple consecutive timepoints;
processing the original data with a sliding window algorithm to obtain a dataset, the dataset comprising multiple operational data sequence samples and an output data sample corresponding to each of the operational data sequence samples; and
training an initial prediction model with the dataset to obtain the well-trained prediction model.

5. The combined prediction method for a PEM device according to claim 4, before the training an initial prediction model with the dataset, further comprising: normalizing the dataset to obtain a normalized dataset, and taking the normalized dataset as a new dataset.

6. The combined prediction method for a PEM device according to claim 4, wherein the training an initial prediction model with the dataset to obtain the well-trained prediction model specifically comprises:
dividing the dataset into a training set and a test set; and
training the initial prediction model with the training set to obtain the well-trained prediction model, and testing the well-trained prediction model with the test set to determine an accuracy of the well-trained prediction model.

7. The combined prediction method for a PEM device according to claim 6, wherein when the initial prediction model is trained with the training set, training parameters comprise a learning rate, a number of training times, a batch size, and a gradient threshold; a mean square error (MSE) serves as a loss function; and an Adam algorithm serves as an optimization algorithm.

8. A computer apparatus, comprising a memory, a processor, and a computer program stored in the memory and executable on the processor, wherein the processor executes the computer program to implement steps of the combined prediction method for a proton exchange membrane (PEM) device according to claim 1.

9. The computer apparatus according to claim 8, wherein the well-trained prediction model comprises two feature extraction blocks, a flatten layer, a dropout layer, and a fully connected layer that are connected sequentially; and
the feature extraction blocks each comprise a first convolutional layer, a pooling layer, an activation layer, a spatial squeeze-and-excitation (sSE) block, a second convolutional layer, a channel SE (cSE) block, a first multiplication layer, a second multiplication layer, and an addition layer; the first convolutional layer, the pooling layer, and the activation layer are connected sequentially; an output end of the activation layer is connected to the sSE block, the second convolutional layer, the cSE block, and the addition layer; an output end of the sSE block is connected to the first multiplication layer; an output end of the second convolutional layer is connected to the first multiplication layer and the second multiplication layer; an output end of the cSE block is connected to the second multiplication layer; an output end of the first multiplication layer is connected to the addition layer; and an output end of the second multiplication layer is connected to the addition layer.

10. The computer apparatus according to claim 8, wherein if the PEM device is the PEM fuel cell, the resistance comprises a 2,500-Hz resistance and a 10-Hz resistance; and if the PEM device is the PEM electrolyzer, the resistance comprises a 1,000-Hz resistance and a 1-Hz resistance.

11. The computer apparatus according to claim 8, before the taking the operational data sequence as an input, and performing combined prediction on output data of the PEM device at a prediction timepoint with a well-trained prediction model, further comprising:
acquiring original data of the PEM device, the original data comprising operational data and output data in the multiple consecutive timepoints;
processing the original data with a sliding window algorithm to obtain a dataset, the dataset comprising multiple operational data sequence samples and an output data sample corresponding to each of the operational data sequence samples; and
training an initial prediction model with the dataset to obtain the well-trained prediction model.

12. The computer apparatus according to claim 11, before the training an initial prediction model with the dataset, further comprising: normalizing the dataset to obtain a normalized dataset, and taking the normalized dataset as a new dataset.

13. The computer apparatus according to claim 11, wherein the training an initial prediction model with the dataset to obtain the well-trained prediction model specifically comprises:
dividing the dataset into a training set and a test set; and
training the initial prediction model with the training set to obtain the well-trained prediction model, and testing the well-trained prediction model with the test set to determine an accuracy of the well-trained prediction model.

14. The computer apparatus according to claim 13, wherein when the initial prediction model is trained with the training set, training parameters comprise a learning rate, a number of training times, a batch size, and a gradient threshold; a mean square error (MSE) serves as a loss function; and an Adam algorithm serves as an optimization algorithm.

15. A computer-readable storage medium, storing a computer program, wherein the computer program is executed by a processor to implement steps of the combined prediction method for a proton exchange membrane (PEM) device according to claim 1.

16. The computer-readable storage medium according to claim 15, wherein the well-trained prediction model comprises two feature extraction blocks, a flatten layer, a dropout layer, and a fully connected layer that are connected sequentially; and
the feature extraction blocks each comprise a first convolutional layer, a pooling layer, an activation layer, a spatial squeeze-and-excitation (sSE) block, a second convolutional layer, a channel SE (cSE) block, a first multiplication layer, a second multiplication layer, and an addition layer; the first convolutional layer, the pooling layer, and the activation layer are connected sequentially; an output end of the activation layer is connected to the sSE block, the second convolutional layer, the cSE block, and the addition layer; an output end of the sSE block is connected to the first multiplication layer; an output end of the second convolutional layer is connected to the first multiplication layer and the second multiplication layer; an output end of the cSE block is connected to the second multiplication layer; an output end of the first multiplication layer is connected to the addition layer; and an output end of the second multiplication layer is connected to the addition layer.

17. The computer-readable storage medium according to claim 15, wherein if the PEM device is the PEM fuel cell, the resistance comprises a 2,500-Hz resistance and a 10-Hz resistance; and if the PEM device is the PEM electrolyzer, the resistance comprises a 1,000-Hz resistance and a 1-Hz resistance.

18. The computer-readable storage medium according to claim 15, before the taking the operational data sequence as an input, and performing combined prediction on output data of the PEM device at a prediction timepoint with a well-trained prediction model, further comprising:
acquiring original data of the PEM device, the original data comprising operational data and output data in the multiple consecutive timepoints;
processing the original data with a sliding window algorithm to obtain a dataset, the dataset comprising multiple operational data sequence samples and an output data sample corresponding to each of the operational data sequence samples; and
training an initial prediction model with the dataset to obtain the well-trained prediction model.

19. The computer-readable storage medium according to claim 18, before the training an initial prediction model with the dataset, further comprising: normalizing the dataset to obtain a normalized dataset, and taking the normalized dataset as a new dataset.

20. A computer program product, comprising a computer program, wherein the computer program is executed by a processor to implement steps of the combined prediction method for a proton exchange membrane (PEM) device according to claim 1.
